(19) United States
(12) Patent Application Publication
(10) Pub. No.: US 2002/0091829 A1
(43) Pub. Date: Jul. 11, 2002

(54) Internet message management portal

(76) Inventors: Christopher (Noah) Wood, Palo Alto, CA (US); Michael D. Kowitz, Campbell, CA (US)

Correspondence Address: MARTINE & PENILLA, LLP, 710 LAKEWAY DRIVE, SUITE 170, SUNNYVALE, CA, 94085, US

(21) Appl. No.: 09/510,424

(22) Filed: Feb. 22, 2000

(51) Int. Cl. G06F 15/16

(52) U.S. Cl. 709/227; 709/206

(57) ABSTRACT

An Internet message management portal implementing program instructions for managing messages of remote message sources by way of the Internet is provided. The instructions include program instructions for establishing message sources for a user. Each message source is associated with access and management information provided by the user. Program instructions are further provided for storing the access and management information for the message sources in a user database and for accessing each of the message sources over the Internet at user defined times using the access and management information. Program instructions are also provided for copying messages from the message sources and for saving the copied messages at a message database. Finally, program instructions are provided to enable web browser access to the portal and to the message database so that the user can access the copied messages, and the copied messages being displayed for the user to handle.

### CROSS REFERENCE To RELATED APPLICATIONS

This application claims priority under 35 U.S.C. § 120 from U.S. patent application Ser. No. 09/433,652, entitled “Personal Message Management System,” and filed on Nov. 3, 1999, and priority under 35 U.S.C. § 119(e) from U.S. Provisional Patent Application No. 60/162,931, entitled “Personal Message Management System,” and filed on Nov. 1, 1999. The disclosures of these applications are incorporated herein by reference.

### BACKGROUND OF THE INVENTION

1. Field of the Invention

This invention relates generally to computer assisted message management, and more particularly to the management and handling of personal messages actively retrieved from different sources by way of the Internet.

2. Description of the Related Art

The growth in modem day communication technology has provided ordinary consumers with powerful yet affordable communication tools. These communication tools range from modem telephone systems that provide sophisticated voice-mail capabilities, cellular telephones having associated voice-mail capabilities, home and office Internet e-mail accounts, wireless Internet e-mail accounts by way of portable computers, text pagers, etc. Although these technologies have provided busy business users as well as ordinary persons with affordable avenues for always keeping in contact with people around the world, these technologies also necessarily introduce a level of complication.

For instance, users that take advantage of these technologies are required to continually check on each of these communication sources to determine whether or not new messages have arrived. Take for example a user that has multiple e-mail accounts (e.g., a home e-mail account, a work e-mail account, and a general Internet e-mail account), a cellular phone voice-mail account, an office voice-mail account, and one or two home voice-mail systems, and a text pager. In order for this user to keep apprised of the most recent messages, this user is commonly required to spend time calling each account to listen to and answer selected messages. For busy people, the time spent in simply retrieving and managing messages can amount to a significant daily required use of ones time. In some cases, users can spend hours each day retrieving messages to determine whether or not such messages are important. The user is forced into spending this amount of time because the user does not know in advance which message is important until the user reads or listens to the messages.

A known way of attempting to handle messages coming from different sources is to use a system referred to as “unified messaging.” In unified messaging, a user having different message sources can actively forward all of the message sources to one number at the unified messaging provider (which can be an Intranet of a company or an outside provider) which stores the messages. To retrieve the messages, the user can then contact the unified messaging provider that provides access to the stored messages. Although this alleviates the need to call up different sources (i.e., the voice-mail of an office phone, a home phone, a cell phone, etc.), the user is forced to forward all calls to the unified messaging provider. It should be noted that telephone companies typically charge a fee to transfer calls to another number, and if all calls are transferred to the unified messaging provider, the monthly bill on transferred calls alone can amount to significant phone bill increases.

Yet another problem with forwarding calls is that the messages are not saved at the target telephone number (i.e., in the office voice-mail system, the home voice-mail system, the cell phone mail system, etc.). As a result, if there were ever a problem with the storage device used by the unified messaging provider, all messages could potentially be lost and thus be unrecoverable. This is sometimes referred to as a single point of failure. Not only is unified messaging time consuming to set up, but it also forces users to change their normal message management behavior. As such, unified messaging can become yet another technological task to manage and maintain as opposed to relieving the user of additional message management.

In view of the foregoing, there is a need for a message management system which can operate over the Internet to actively access message sources, retrieve relevant messages, and present the messages to the user in an organized manner.

### SUMMARY OF THE INVENTION

Broadly speaking, the present invention fills these needs by providing computer methods for managing and handling personal messages of different types that are actively and intelligently retrieved from different sources over the Internet. It should be appreciated that the present invention can be implemented in numerous ways, including as a process, an apparatus, a system, computer readable media, or a device. Several inventive embodiments of the present invention are described below.

In one embodiment, a method for managing messages of remote message sources over the Internet is disclosed. The method includes establishing message sources for a user, such that each message source has associated access and management information provided by the user. The method then proceeds to store the access and management information for the message sources in a user database. Each of the message sources is accessed over the Internet at user defined times or on demand using the access and management information. Messages are then copied from the message sources and then stored into a message database. Once in the message database, the user can log on to the Internet to view, access, and respond to any message provided for the user in the message database.

In another embodiment, a message management system is provided for handling personal messages from different message sources over the Internet. The message management system includes a user database having access and management information set by a user. The access information is configured to be used to gain access to each of the different message sources and the management information is configured to set access times to each of the different message sources. A procedures database is also provided for holding access routines for the different message sources. A phone server for establishing Internet phone connections to voice-mail-type message sources and an e-mail server for establishing Internet connections to e-mail-type message sources are also provided. A message database for holding messages copied from selected ones of the different message sources is also included. Then, a manager server that is in contact with the user database and the procedures database is provided. The manager server is configured to request that one or both of the phone server and the e-mail server establish Internet connections to the selected message sources. The manager server is further configured to pass both access and management information from the user database and access routines from the procedures database to the phone server and e-mail server. Once the message management system has actively retrieved messages from the different sources at the user defined times, the user can simply log on to the system over the Internet and view all retrieved messages and respond if desired.

In yet another embodiment, a computer readable media having program instructions for managing messages of remote message sources over the Internet is provided. The computer readable media includes: (a) program instructions for establishing message sources for a user, and each message source has associated access and management information provided by the user; (b) program instructions for storing the access and management information for the message sources in a user database; (c) program instructions for accessing each of the message sources over the Internet at user defined times using the access and management information; (d) program instructions for copying messages from the message sources; and (e) program instructions for saving the copied messages at a message database.

In still a further embodiment, a method for managing messages of remote message sources over the Internet is provided. The method includes: (a) establishing message sources for a user (e.g., adding an office phone account, adding an e-mail account, etc.), and each message source has access and management information provided by the user; (b) storing the access and management information for the message sources in a user database; (c) accessing each of the message sources over the Internet at user defined times or on demand using the access and management information, the accessing is performed over the Internet; (d) copying messages from the message sources at the user defined times; (e) saving the copied messages at a message database; and (f) accessing the message database over the Internet to access the copied messages. The copied messages are displayed for the user to handle, and each copied message is arranged in the display with the message source from which the copied message originated, and the accessing of the message database can be performed over a web browser.

The message management system of the present invention is a powerful solution for busy persons desiring control over their messaging sources. The message management system is a non-invasive solution which does not require a user to change his or her normal routine. That is, the user is not required to forward calls to one number, and the user is able to access all message sources from any location in the world having an Internet connection. The system provides an easy to use interface that organizes each message in relation to where the message was retrieved from. Still another advantage of the message management system is that users are able to quickly browse through all messages from all sources in text format (whether the original message was voice or text) so that non-important messages are not accessed until the user desires. The invention automatically standardizes the functionality of all voice-mail systems regardless of the manufacturer.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows a general diagram of a message management system in accordance with one embodiment of the present invention.

FIG. 2 shows a model block diagram of the components that comprise the message management system provided by amessage.com, in accordance with one embodiment of the present invention.

FIG. 3 illustrates a flowchart that defines the sign-up process for a new user of amessage.com that implements the message management system, in accordance with one embodiment of the present invention.

FIG. 4 illustrates a flowchart diagram in accordance with one embodiment of the present invention detailing the method operations performed when retrieving voice-mail from the message management system.

FIG. 5 illustrates a flowchart diagram defining the operations performed to retrieve e-mail messages in accordance with one embodiment of the message management system.

FIG. 6A illustrates a flowchart diagram defining the method operations performed when a user obtains messages from the message management system by way of the Internet, in accordance with one embodiment of the present invention.

FIG. 6B illustrates a simplified graphical user interface (GUI) that illustrates preferred organization of messages for a user, in accordance with one embodiment of the present invention.

FIGS. 6C and 6D illustrate exemplary GUI's for configuring the settings for each of the messages sources, in accordance with one embodiment of the present invention.

FIG. 6E illustrates is a graphical diagram of the method operations and user interfaces for responding to messages, in accordance with one embodiment of the present invention.

FIG. 7 illustrates a flowchart diagram defining the process for retrieving web-based e-mail, in accordance with one embodiment of the present invention.

### DETAILED DESCRIPTION OF THE PREFERRED EMBODIMENTS

An invention is described for computer methods for managing and handling personal messages of different types that are actively and intelligently retrieved from different sources over the Internet. It will be obvious, however, to one skilled in the art, that the present invention may be practiced without some or all of these specific details. In other instances, well known process operations have not been described in detail in order not to unnecessarily obscure the present invention.

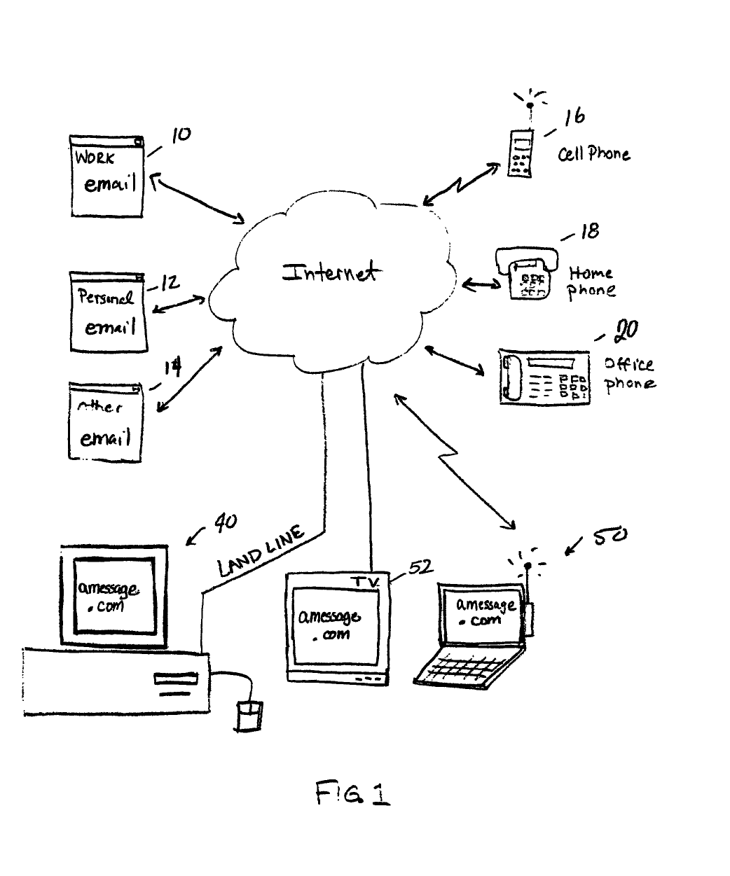

FIG. 1 shows a general diagram of a message management system in accordance with one embodiment of the present invention. The message management system is configured to actively and intelligently communicate with the Internet to access and manage communication message sources. For example, the message management system retrieves e-mail messages from various e-mail servers (e.g., POP3, Web based, etc.) and voice-mail from various voice mail systems (e.g., PSTN, voice over IP, etc.), and web-based fax retrieval as well as other multimedia messages of the future. Other multimedia sources may include video sources and other associated multimedia functionalities. Such communication message sources may include, for example, work e-mail 10, personal e-mail 12, other e-mail 14, cellular phone 16, home phone 18, and office phone 20. Other sources may also include e-mail messages obtained from a WebTV™ source, and other messaging devices that may be connected to the Internet by phone lines or wireless connections.

In a preferred embodiment of the present invention, the message management system functions over the Internet and provides a user access to his or her messages from any Internet browser. As an example, the owner of the present application provides a message accessing and managing portal, named “amessage.com,” for easy setup (i.e., the establishment of message sources during registration) and access by users desiring to minimize the time consuming task of checking messages with prior art technology. The amessage.com portal can therefore be accessed by communicating with the Internet through any personal computer system 40, any television Internet connection 52, and any portable computer 50. The communication links can therefore be by way of land lines, wireless connections, and any other suitable techniques.

The message management system provided by amessage.com is configured to allow a user to establish all of its e-mail accounts, voice-mail accounts, fax accounts, and other multimedia accounts. The voice-mail accounts can include, by way of example, office voice-mail accounts, cell phone accounts, and other communication devices. The message management system will utilize the Internet to automatically retrieve any messages that may be sitting at any one of the user's communication sources. As will be described below in greater detail, during the setup process, the user is prompted to provide information for accessing the different e-mail accounts, voice-mail accounts, etc. This information will thus enable the message management system of amessage.com to intelligently go out to each one of these sources (at particular times or on demand) and make a copy of the messages for the user to view through the amessage.com portal at any time from any Internet connection throughout the world.

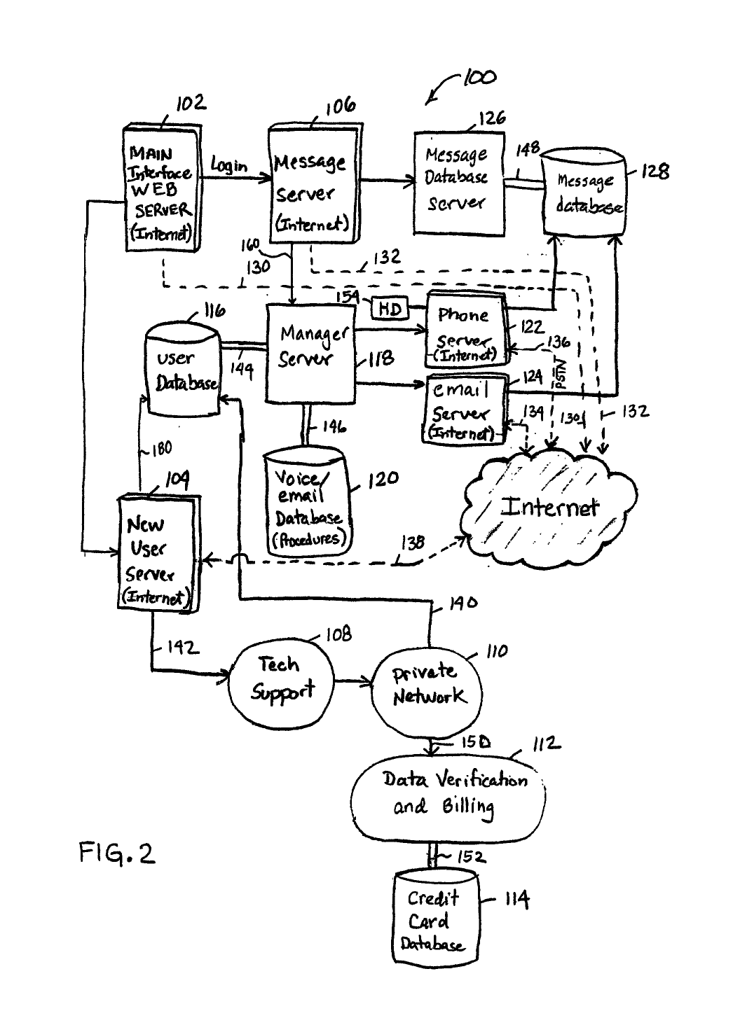

FIG. 2 shows a model block diagram 100 of the components that comprise the message management system provided by amessage.com, in accordance with one embodiment of the present invention. The user will first access the main interface web server 102 which provides the amessage.com portal for either logging on to check messages if the user was previously registered as a user, or for beginning the sign-up process if the user is new user. If the user is a new user, the message management system will send the user to a new user server 104 which is configured to control the initial sign-up process of a new user desiring the capabilities of the message management system.

While the user is signing up at the new user server 104, the method may proceed by a communication link 142 to technical support 108. In technical support 108, the user can contact a representative of amessage.com by telephone or via the web or other medium for technical support and assistance during the initial sign up process. This technical support is most helpful in assisting users to identify the user's correct phone system, the type of e-mail accounts, and to properly identify the log-on sequences, and passwords for accessing voice-mail and/or fax or multimedia store and forward devices. Alternatively, the technical support 108 can be in the form of a comprehensive computer program, which intelligently provides the new user advice or suggestions. While the user is providing the sign up information, this information can, in one embodiment, be tested on a private network 110. If the case where the user wants to access technical support by phone, and the lines are busy, the system is preferably configured to automatically call back the user at a later time. In addition, to prevent message source redundancy, in another embodiment, it is preferred that all message source identifying information (e.g., phone numbers and e-mails) be stored in a separate database. This database can then be checked to prevent such redundancy.

The private network 110 is a preliminary network that is controlled by technical support 108 to assist the user in initially testing whether or not the information provided to access voice-mail, e-mail, and the like, is correct and functioning (i.e., before the account goes live). The technical support 108 (whether assisted by a human or by a computer assisted program) together with the private network 110 will therefore ensure that new users are correctly registered and subsequently able to utilize the full functionalities of the message management system of the present invention. In certain circumstances, if the technical support 108 were not provided and testing was not performed by way of the private network 110, the user may accidentally provide the wrong information for either logging on to a voice-mail system, or the wrong information for accessing e-mail accounts. As such, the technical support 108 and the testing provided at the private network 110 will ensure that the data is accurate and provides the new user with full functionality to the desired services provided by amessage.com.

During the testing provided by the private network 110, the information provided by the user that is configured to identify billing particulars is passed to a data verification and billing module 112. The data verification and billing module 112 will thus verify that the credit card information or other billing information provided by the user is acceptable by amessage.com and is accurate for billing services rendered. Once verification is complete by the data verification and billing module 112, the billing information is provided by way of a secure shell 152 to a credit card database 114. The credit card database 114 is therefore secure such that the highest level of security is provided for users that provide sensitive credit card information over the Internet.

Once the data verification and the billing information is processed by the module 112, the private network 110 will then allow the information associated with the new user to be communicated to a user database 116 by way of communication link 140. The information provided to the user database will include information such as user passwords for accessing the different message sources and the like. A manager server 118 is provided with a secure shell 144 to the user database 116 which holds the passwords and related accessing information. The manager server 118 is also coupled to a voice/e-mail database 120 by way of a secure shell 146. The voice/e-mail database 120 will thus hold, in the case of voice-mail, menus of numbers to enter for each type of phone system that may be supported by the message management system. In general, the voice/e-mail database 120 is a procedures database that can be implemented to generically gain access to common systems, without regard to particular user members.

Because the number of phone systems that are widely used are in fact limited, and there are several brands and models that are most frequently used, the voice/e-mail database 120 can preferably include all of the relevant menu structures and log-on procedures for the different types of phone systems that are commercially available. Of course, the database 120 can also be updated from time to time with information for new phone systems that may become available in the future.

The manager server 118 is configured to communicate with the user database 116 and process through all users to determine which users would like messages to be accessed at particular times (e.g., using timed processes). For example, if a particular user had selected during the set-up process that it desires to have all of its voice-mail messages called up at 6:00 a.m. in the morning, the manager server 118 would then wake up from a sleep process at 6:00 a.m. and go out to the user database 116, retrieve that information over the secure shell 144, and then communicate that information to the phone server 122. The phone server 122 will then have information regarding the user's passwords, the voice-mail systems from the user database 116, and the voice-mail/e-mail database 120, respectively. The phone server 122 can then communicate over the Internet by link 136 to retrieve voice-mail messages from each of the voice-mail sources. For example, the phone server 122 will send out information over link 136 to the Internet so calls can be automatically placed over the Internet to each of the user's voice-mail accounts. An example is using a voice over IP gateway for the long distance portion of a call and the PSTN for the last mile to the voice-mail system. If a gateway is not available, the PSTN is used for the entire long distance and local aspects of the call.

Each voice-mail account will then be accessed to record a copy of the messages without erasing the message from the voice-mail source if the user desires, and then pass each of the voice-mail messages to a message database 128. When the phone server 122 retrieves a copy of the entire voice-mail message, the voice-mail messages are stored on a local hard drive 154 (compressed or uncompressed). The phone server 122 can convert an initial portion of the voice-mail into text and provide that text portion to the message database 128. In one embodiment, when the user logs into view his or her messages, the messages are retrieved initially from the message database 128 and only the headers of the voice-mails and the headers of the e-mails in text format are provided for viewing. In this manner, the user can easily and quickly identify which e-mails or voice-mails are important to read or listen to at that particular time. If a particular voice-mail is desired to be listened to at that time, the phone server 122 can provide the entire voice-mail message to the message database 128 so that the user can listen to the entire voice-mail message at that time.

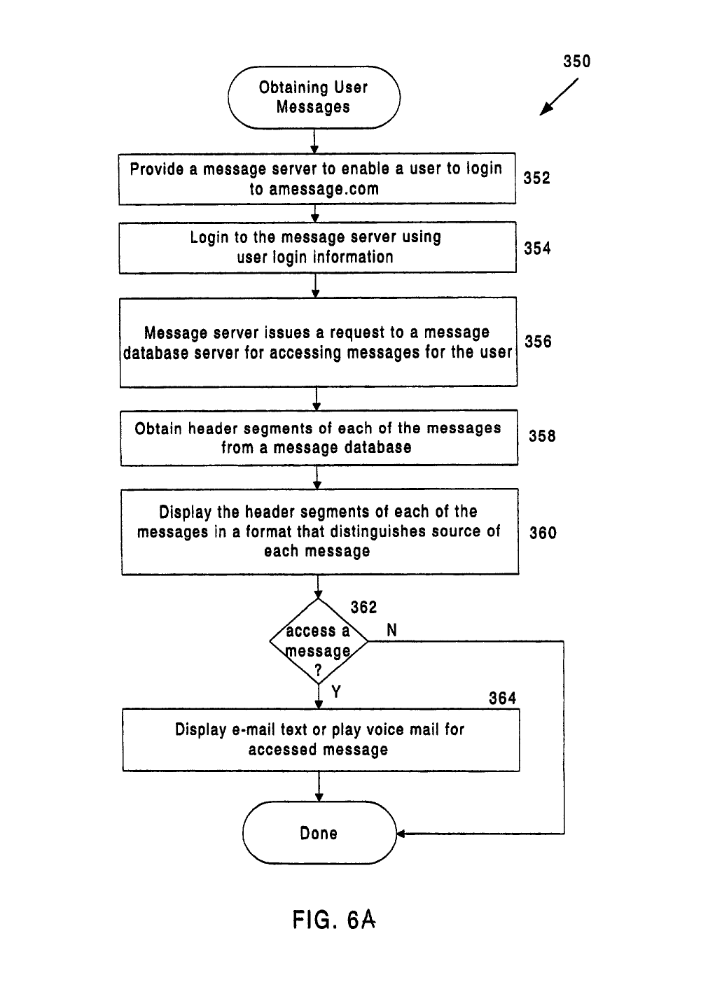

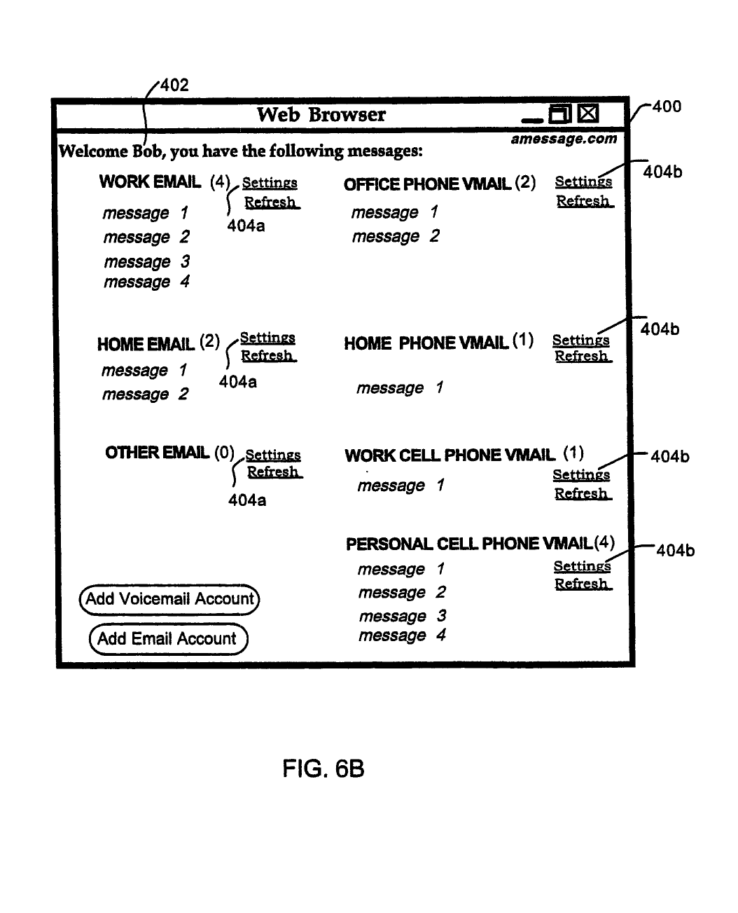

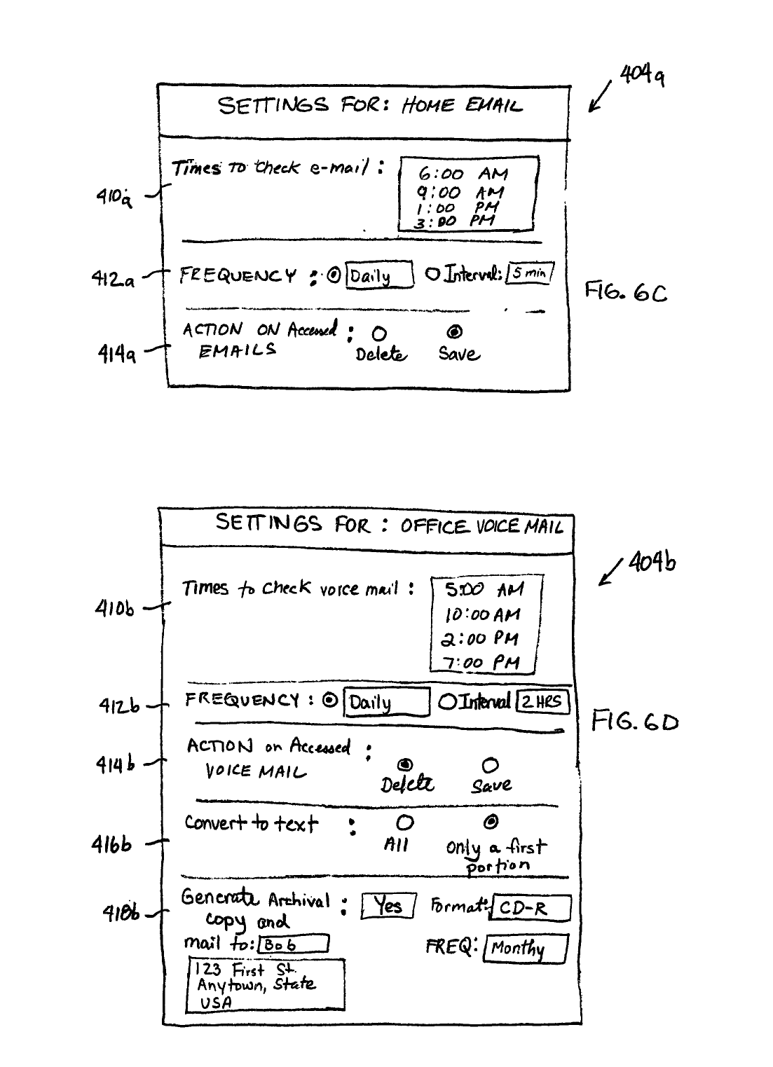

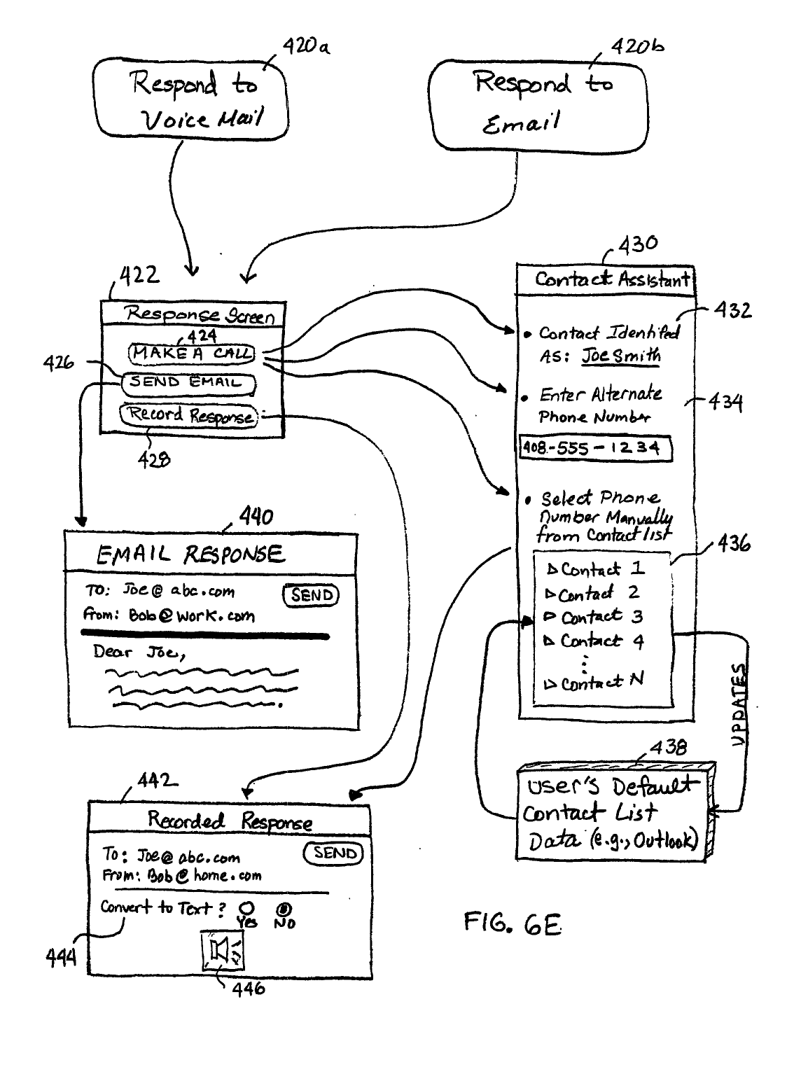

As an over view, the amessage.com portal communicates to the Internet via communication line 130 so that the user can log into a message server 106, the message server 106 communicates to the Internet by way of a communication line 132. The message server 106 will then communicate by way of a secure connection to a message database server 126. The message database server 126 which is part of the message management system will then allow the user (who logged on using a proper user name and password) to communicate to the message database 128. The communication to the message database 128 is preferably by way of a secure connection 148. In general, the amessage.com portal will provide a graphical user interface which itemizes the different messages that may have been retrieved by the message management system from the different sources that were programmed by the user (e.g., see FIG. 6B).

In a similar manner, if the user had programmed into desired settings that he or she desires the message management system to retrieve e-mail messages at a particular time of day, that information will be resident in the user database 116. As the manager server 118 runs timed (e.g., sleep processes) processes to determine when the next retrieval will occur, the manager server 118 will access an e-mail server 124 and provide the e-mail server 124 information for signing on to particular e-mail accounts. This information will come from the voice/e-mail database 120 and the user database 116. The e-mail server 124 will then access the Internet by communication line 134 where each of the accessed e-mail messages is copied from the source and then transferred to the message database 128. At the option of the user, the e-mail messages can either be erased or saved after being accessed.

As described above, when the user desires to log in to the amessage.com portal, the user will be able to graphically view each of his or her voice-mail messages, and e-mail messages in one easy to view graphical screen. The graphical screen will preferably itemize each of the messages to identify the source from which each message was retrieved from. Because the user is able to quickly glance at the different messages that may be present in the message database 128, the user can quickly determine which e-mail messages, voice messages, or other multimedia messages are of high importance and postpone listening to any such voice-mails or e-mails until a future date. It is also important to note that the message that was accessed by the message management system over the Internet can be saved at the source (i.e., without erasing the source message). In this manner, if the user desires to listen to the message at a later time from the source, the message will still be present. Of course, the user can in its settings, determine if it desires to have the original source message erased.

In yet another embodiment, communication 160 can be made between the message server 106 and the manager server 118 to enable the user to immediately check any or all messages. In addition, the new user server 104 can update 180 the user database 116 with simple modifications (e.g., save or delete messages from source, or change time to check messages).

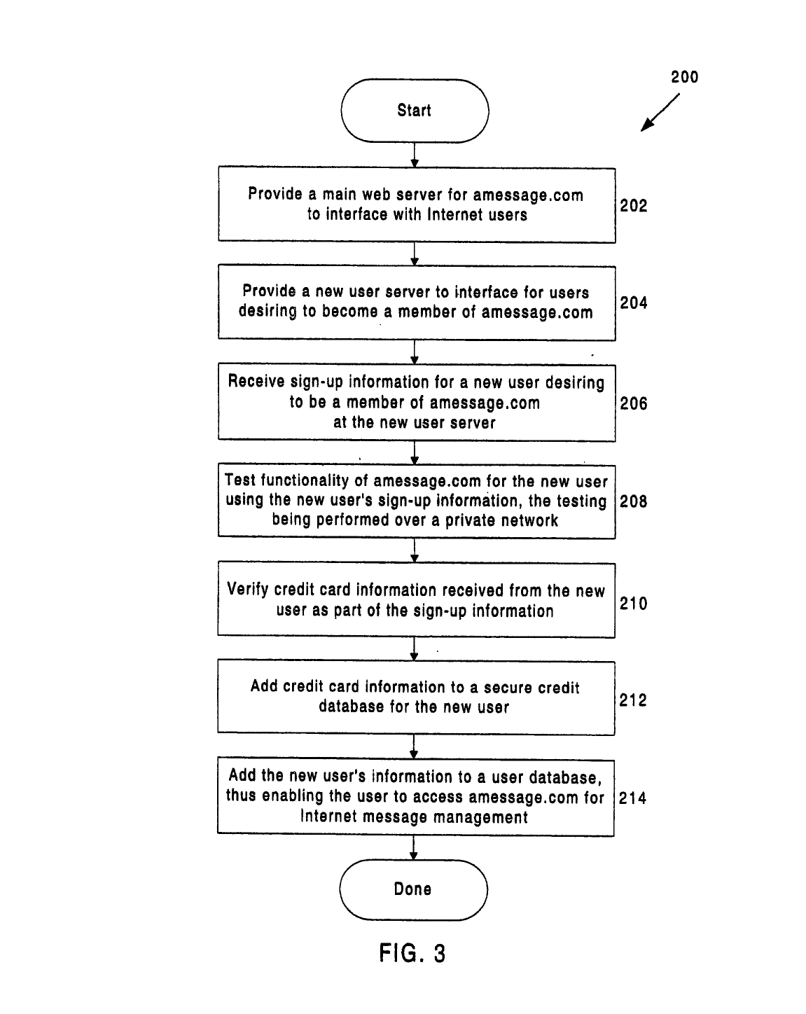

FIG. 3 illustrates a flowchart 200 that defines the sign-up process for a new user of amessage.com that implements the message management system, in accordance with one embodiment of the present invention. The method begins at an operation 202 where a main web server is provided for amessage.com to interface with Internet users. In operation 204, a new user server is provided to interface for users desiring to become a member of amessage.com such that the user can take advantage of the services provided by the message management system. Once the user is linked to the new user server 104 of FIG. 2, the user is prompted to provide particular information for accessing their desired e-mail accounts, voice-mail accounts, and the like.

For instance, the user may be asked to provide the name that it wants to call the particular mailbox. Once the name has been provided for a particular mailbox, for example, office voice-mail, the user is prompted to provide information with regard to the voice-mail system. After the user has provided the information for the voice-mail system, (e.g., a Nortel Meridian Mail™ system, a PacBell Message Center™ system, etc.), the user is prompted to provide the telephone number to dial for accessing the particular voice-mail system. The user will also be asked to provide the password for accessing voice-mail on that system. To ensure reliability, the user may be asked to re-type the password of the voice-mail system to ensure that the proper password has indeed been provided.

Now that the password has been provided, the user will be asked several questions regarding the frequency of when the message management system is to access the particular voice-mail account. After all of the relevant information has been provided to the user database 116 and the voice/e-mail database 120 of FIG. 2 by way of the sign-up procedures, the method will move to operation 208 of FIG. 3. In operation 208, the functionality of amessage.com for the new user is tested using the new user's sign-up information. The sign-up information will thus be provided to a private network for testing before the user's account is activated.

The testing is performed to ensure that the message management system will indeed be able to access the desired voice-mail systems before the user is allowed to complete the new user sign-up procedures. In one embodiment, the user may be assisted by technical support to provide the relevant information for accessing different types of voice-mail accounts, providing the password information, and relevant data for accessing the different types of voice-mail systems. The technical support will thus interface with the private network 110 of FIG. 2 to enable testing of the information provided by the user.

This testing will include generating test requests for messages from desired voice-mail systems to ensure that the user's message management properties have been properly set and are in condition for use. Once the functionality has been tested in operation 208, the method proceeds to an operation 210 where credit card information received from the user is verified to ensure that the account can be billed for services provided by amessage.com. Once the credit card information has been processed and verified, the credit card information is added to a secure credit card database for the particular user and will be accessed to bill the user at appropriate times.

Now that the user's credit card information has been verified and added to a secure credit card database in operation 212, the method moves to an operation 214 where the new user's information is added to a user database. It should be understood that the order in which the testing and/or verification is performed is not of importance. Accordingly, the methods of the present invention can be practiced in any order that may be desired or programmed. The user database is, by way of example, user database 116 of FIG. 2 and is in communication with the manager server 118. The user database will therefore enable the manager server to use the information provided by the user and stored in the user database for accessing and determining when to access messages at the different sources identified by the user.

As pointed out above, the message management system implements the Internet to access the different message sources (i.e., office voice-mail, home voice-mail, e-mail accounts, and the like), such that the user will not be required to forward calls from the message sources as is done in the prior art. In a preferred embodiment, the user will be allowed to determine whether or not the voice-mail messages are to be saved or deleted once they are copied from the voice-mail sources to the message database 128 or the hard drive 154 of the message management system of FIG. 2. Of course, the user may be suggested to instruct the message management system to save all messages once they have been copied to the message management system so that a copy is maintained at the source in case the user is unable to access the Internet, or the user wants to access the message from the source at a future time.

As mentioned above, the phone server 122 of FIG. 2 may have connected thereto a hard drive 154, and a backup system which is capable of periodically generating archival media copies for users. By way of example, the phone server also has connected thereto (or by way of the Internet at a remote location) a number of drives (e.g., CDR drives, disk drives, zip drives, tape drives, etc.), for creating the archival copies from the hard drive 154 or the message database 128. The media can then be sent to the user for storage. In this manner, the hard drive 154 or the message database will not indefinitely hold voice-mail messages. Alternatively, the user may instruct the message management system to erase all or selected messages after a predetermined amount of time from the hard drive 154 and/or message database.

In still another embodiment of the present invention, the user may be provided a user interface (UI) (i.e., at the amessage.com portal) to access his or her voice-mail systems. This UI is used during the set up process (as opposed to using the above described set up process) to gather voice-mail accessing information. For instance, the user may be asked by way of the UI to access his or her voice-mail systems through Internet at the amessage.com portal. As the user accesses his or her voice-mail systems, the message management system will track the information being input by the user to memorize the process of accessing the systems. This also verifies to the use that he can actually access his message sources and the message management system will also be able to do the same in the future once the system is active.

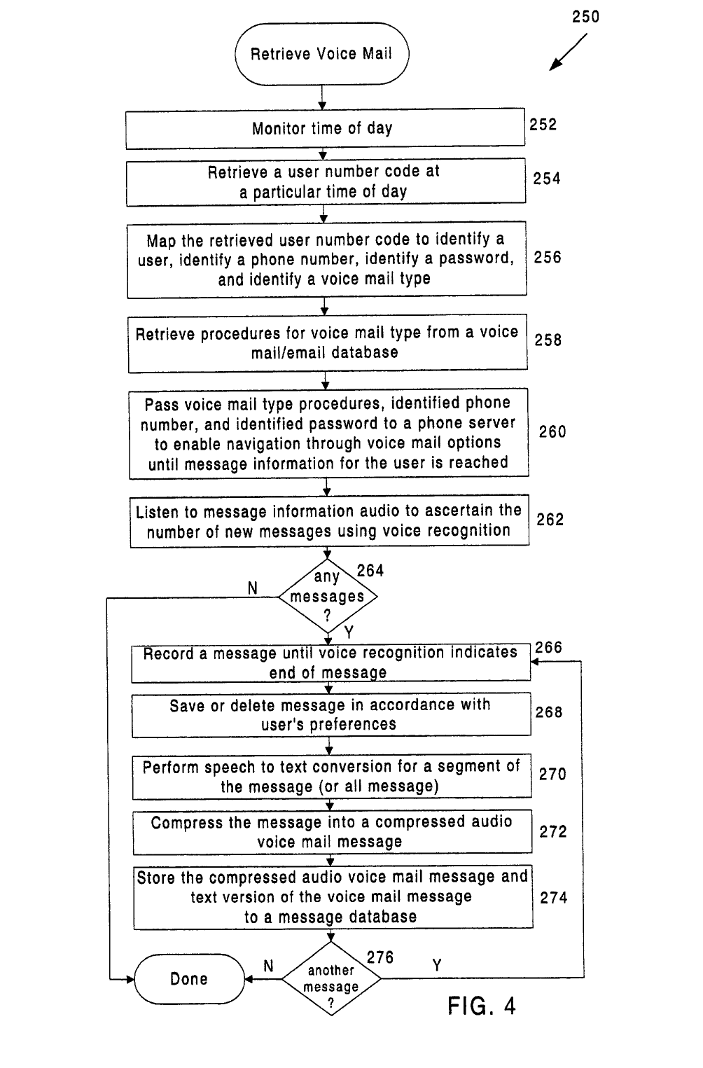

FIG. 4 illustrates a flowchart diagram 250 in accordance with one embodiment of the present invention detailing the method operations performed when retrieving voice-mail from the message management system. The method begins at an operation 252 where the time of day is monitored by the manager server 118 of FIG. 2. For each user in the user database, different times have been set for the manager server 118 to go out and actively retrieve voice-mail and/or e-mail over the Internet.

The method now moves to operation 254 where a user number code is retrieved at a particular time of day. The user number code, for additional security purposes, is initially randomly generated. Once the user number code has been retrieved in operation 254, the method will proceed to an operation 256 where the retrieved user number code is mapped to identify a user, identify a phone number, identify a password, and identify a voice-mail type. Once this information has been retrieved using the user number code, the method proceeds to an operation 258 where procedures for accessing and controlling the particular voice-mail type is retrieved from a voice/e-mail database. As discussed above, each voice-mail type may have different procedures for accessing voice-mail, and such procedures will be stored in the voice-mail/e-mail database 120 of FIG. 2. In this manner, the voice-mail procedures for a limited number of voice-mail systems will be stored in the voice-mail/e-mail database 120 and will not have to be repeated over and over again for each user in the user database 116 that may have the same voice-mail system.

At this point, the method proceeds to an operation 260 where the voice-mail type procedures, the identified phone number, and the identified password to a phone server are passed to enable navigation through voice-mail options until message information for the user is reached. If a human user picks up the phone when the message management system calls on a scheduled time, the system is configured to recognize that a human has picked up. At that point, the message management system will provide the human user with option so that voice-mail can be accessed at a later time. For example, the system can ask the user to specify when to call back (e.g., within 1 hour) or to cancel the call back. Alternatively, the message management system may hang up when it detects a human answering the phone. The system will then call back lager after set time has passed. If the human that answers the phone is no longer a registered user or a wrong target user, the system will ask the human to indicate the same by pressing a selection. By way of example, the message information may be the actual voice message left by a person trying to reach the user at a particular voice-mail account. Now that the phone server has the relevant information for accessing voice-mail and has reached a particular message, the method proceeds to an operation 262 where the message information audio (e.g., the speech of the voice-mail system) is observed (by the message management system) to ascertain the number of new messages using voice recognition. In one embodiment, voice recognition may include matching waveforms using probability, or other suitable techniques known in the voice recognition art.

At this point, the method proceeds to a decision operation 264 where it is determined if there are any messages at the particular voice-mail source. If there are no messages, the method will be done for the particular retrieval of a message. Alternatively, if there are messages based on what the message management system listened to, the method will proceed to an operation 266 where a message is recorded until voice recognition finds the end of the message using in one instance existing keywords in the voice-mail system. Now that the message has been recorded in operation 266, the method proceeds to an operation 268 where the message can be saved or deleted in accordance with the user's preferences. The method then proceeds to an operation 270 where speech-to-text conversion is performed for a segment of the message if desired (e.g., FIG. 6D).

As discussed above, the speech-to-text conversion is performed to enable a text header to be stored in the message database 128 while maintaining the remainder of the message at a hard drive of the phone server 122 or other server. Alternatively, the entire message can be converted to text and stored in the message database 128. The method now proceeds to an operation 272 where the message is compressed into a compressed audio voice-mail message. Now that the message has been compressed, the method moves to an operation 274 where the compressed audio voice-mail message is stored (on the hard drive or the message database 128) and the text portion of the voice-mail message is sent to the message database 128. At this point, it is determined whether there are more messages in decision operation 276 by iteration of the parsed voice recognition given at the beginning of the voice-mail prompt. If there are more messages, the method will then proceed back up to operation 266. The method will therefore continue to run through operations 266 through 274 until all messages have been recorded and it is determined that no more messages remain and the operation of retrieving voice-mail will be done.

In another embodiment, if the message management system has access to a “back door” of a phone system, it is not necessary to navigate through the voice recognition as described above (i.e., or normal user procedures). An example might be Internet access to a voice mail system.

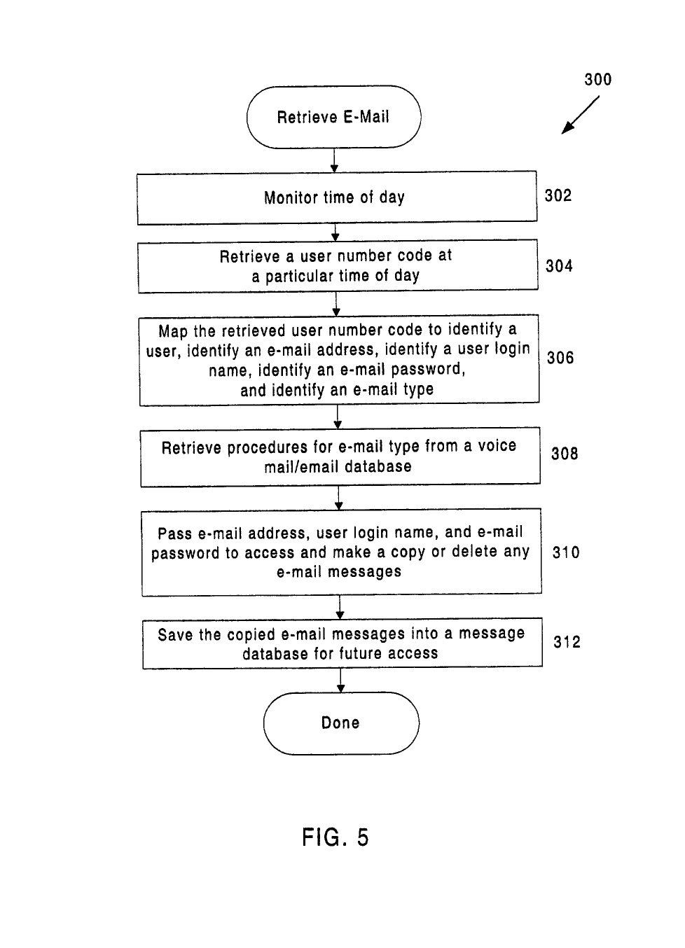

FIG. 5 illustrates a flowchart diagram 300 defining the operations performed to retrieve e-mail messages in accordance with one embodiment of the message management system. The method begins at an operation 302 where the time of day is monitored by the manager server 118 of FIG. 2. The method then proceeds to an operation 304 where a user number code is retrieved at a particular time of day. In this embodiment, the user number code was retrieved due to a setting by the user indicating that the message management system should retrieve a particular e-mail message.

The method now proceeds to an operation 306 where the retrieved user number is mapped to identify a user, identify an e-mail address, identify a user log-in name, identify an e-mail password, and identify an e-mail type. At this point, the method will proceed to an operation 308 where the manager server 118 will retrieve procedures for the e-mail type from the voice-mail/e-mail database 120 of FIG. 2. Once the procedures for the e-mail type have been retrieved in operation 308, the method will proceed to an operation 310 where the e-mail address, user log-in name, and e-mail password to access and make copies of any e-mail messages is passed to the e-mail server 124 of FIG. 2.

The e-mail server 124 will then log in to the desired e-mail address and make the copy of the e-mail message or messages. In this embodiment, the message management system will preferably leave the original message at the e-mail address to allow the user to have future access to that message, if desired. The method now proceeds to an operation 312 where the copied e-mail message is saved into a message database for future access through the amessage.com portal. The message database, in this example, may be the message database 128 of FIG. 2 which can be accessed by a user desiring to check up on current e-mail messages from a particular e-mail account or all of its particular e-mail accounts. When logged in, the user will also be able to access any desired voice-mails.

FIG. 6A illustrates a flowchart diagram 350 defining the method operations performed when a user obtains messages from the message management system by way of amessage.com portal as described with reference to FIG. 2. The method begins at an operation 352 where a message server is provided to enable a user to log into the amessage.com portal. In one embodiment, a cookie is saved onto the user's hard drive so that when the user access the amessage.com portal, the user will be informed of how many messages are waiting to be accessed. Thus, the user need not log in at all if no messages are present. It should be apparent that the name of the portal is not of any importance, and the name is only used herein for illustrative purposes. The method now proceeds to an operation 354 where the user can log in to the message server using log-in information as described with reference to FIG. 2.

The method now moves to an operation 356 where the message server issues a request to a message database server for accessing messages for the user. At this time, the message server will obtain header segments of each of the messages. As shown in FIG. 6B, once the user has logged in, the messages for each message source are identified and listed showing a header of each message (e.g., shown herein as “message 1”, “message 2”, etc.). In one embodiment, the times for the appropriate time zones are indicated for each gathered message. The header of each message may be, for example, the first few sentences of a voice-mail message, or the regarding information of an e-mail message. At this point, the method at operation 360 displays the messages in a format that distinguishes the source of each message.

Again, with reference to FIG. 6B, the source of each message is intelligently arranged and associated with each message source. As described above, a message source may be, a home voice-mail system, an office voice-mail system, a home e-mail account, a work e-mail account, a personal Internet e-mail account, answering machine and the like. The method now proceeds to a decision operation 362 where it is determined whether the user wants to access a particular message. If the user wants to access the particular message, the method will proceed to an operation 364 where the e-mail text is displayed for the user or the message is played as an audio file for the accessed voice-mail message.

By way of example, if the user clicks on one of the voice-mail messages, the message management system will play the message by way of a computer's audio output. It should be understood that the displaying of e-mail text or the playing of voice-mail messages can be repeated for any of the messages that are provided to the user by way of the amessage.com portal.

FIG. 6B illustrates a simplified graphical user interface (GUI) 400 that illustrates preferred organization of messages on amessage.com portal for a user Bob 402, in accordance with one embodiment of the present invention. This GUI 400 is preferably rendered by a web browser, which is capable of processing standard web-based software code. In this exemplary illustration, user Bob has registered work e-mail, home e-mail, other e-mail, office voice-mail, home voice-mail, work cell phone voice-mail, and a personal cell phone voice-mail. When Bob logs on, Bob is presented with all of its messages that have been retrieved by the message management system. In those cases where the user wants to refresh messages for a particular source, or for all sources, the message management system can perform an on-demand retrieval of messages while the user waits. Because the message management system may take several seconds or even a couple of minutes to retrieve messages, it is generally more beneficial to rely on the messages that have previously been retrieved per the user's set schedule.

Also illustrated is are settings links 404a for e-mail sources and settings links 404b for voice-mail accounts. Reference is now made to FIGS. 6C and 6D, which are GUI's for configuring the settings for each of the message sources. For example, settings 404a illustrate settings for the home e-mail source. The message management system was set by the user to check e-mail 410a at several times during the day. In one embodiment, the system can also be set to check e-mail messages every hour, every 5 minutes, or at any other interval desired by the user. This option can be set if the user wants a frequency 412a to be other than every day. For instance, when the user sets particular times to check for e-mail, the user will want to select daily, weekly, etc., as opposed to an interval schedule. Once the message is accessed and copied, the user can set the action on the e-mail 414a to save or delete e-mails at the source. In still another embodiment, to enable users of different computer systems (e.g., Windows™, UNIX™), to listen to voice mail files, Java™ is used to play one compressed format through a web browser.

For settings 404b, the user can control voice-mail settings in a similar manner as settings 404a are controlled. For example, the user can set the message management system to check voice-mail 410b at different times during a day. The frequency 412b can also be custom set by the user. The action on the voice-mail 414b can be set to either delete or save the accessed voice-mail. For voice-mail, however, the user can convert 416b all or a portion of the voice-mail into text. If a portion is converted, the converted portion is preferably the first part of the voice-mail. The converted voice-mail is then used as a header in FIG. 6B for “message 1,” for example. Additionally, the user can also request that an archival copy 418b be generated. The generation of an archival copy can be made in any number of formats.

In one example, the format can be in the form of a CD-R media, which can be generated at different intervals. Once generated, the user can specify where the archival copy should be sent. As discussed above, the archival copy is made from the messages stored in the hard drive connected to the phone server and/or the message database. The archival copy can be generated on site where the message management system is maintained or at a remote location. The remote location can be connected by way of a network, and even over the Internet.

FIG. 6E illustrates a graphical diagram of the method operations and user interfaces for responding to messages, in accordance with one embodiment of the present invention. In the case where a user wants to respond to a voice mail 420a through the amessage.com portal, the user will be presented with a response screen 422. Once at the response screen 422, the user can select a mode to respond to the voice-mail. In one embodiment, the user can select to make a call 424, send an e-mail 426, or record a message 428. When the user selects to make a call, the message management system will employ a contact assistant 430, which is provided to facilitate responding to messages. In the case of a voice-mail, the message management system will be configured to perform caller ID operations to attempt to detect who the voice-mail was from. If the call is identified 432, the contact assistant 430 may identify the caller as “Joe Smith.” At that point, the user can make an Internet phone call by clicking on “Joe Smith.”

If the user wants to enter an alternate number 434, the user needs only to enter the phone number in the field and press return or the like. In yet another embodiment, the user who is working from its base computer, or has access to its base computer, the user's default contact list 438 may be accessed. The data is then provided in 436 to facilitate selection and calling. If the user adds a new contact, that update is also preferably sent back to the user's default contact list. This ensures that the user's contact list is continually updated.

Now assume the user wants to send an e-mail in response to either an e-mail 420b or a voice-mail 420a. When the user selects “send e-mail” 426, the user is provided an e-mail response shell 440, which fills in the FROM information for the user Bob and the TO information (either manually, from the contact list, or from the original message). An important feature here is that the FROM e-mail address will correspond with that of the “source.” That is, if the source had been work e-mail, then the FROM e-mail address would be appropriately filled in so that the recipient will think that the user Bob is actually responding from the e-mail address that received the e-mail message. Accordingly, the message management system is transparent to people who are communicating with the user of amessage.com. Still further, the system can be configured to respond to e-mail messages anonymously.

In still another embodiment, if the user had selected to respond by recording a response 428, the user would be provided with a record response screen 442. In this embodiment, the user Bob may want to convert 444 the recorded message to text. If this is desired, the user is provided with that option before the user sends the message. If the message is not converted to text, the message can be sent as an e-mail voice file 446 attachment.

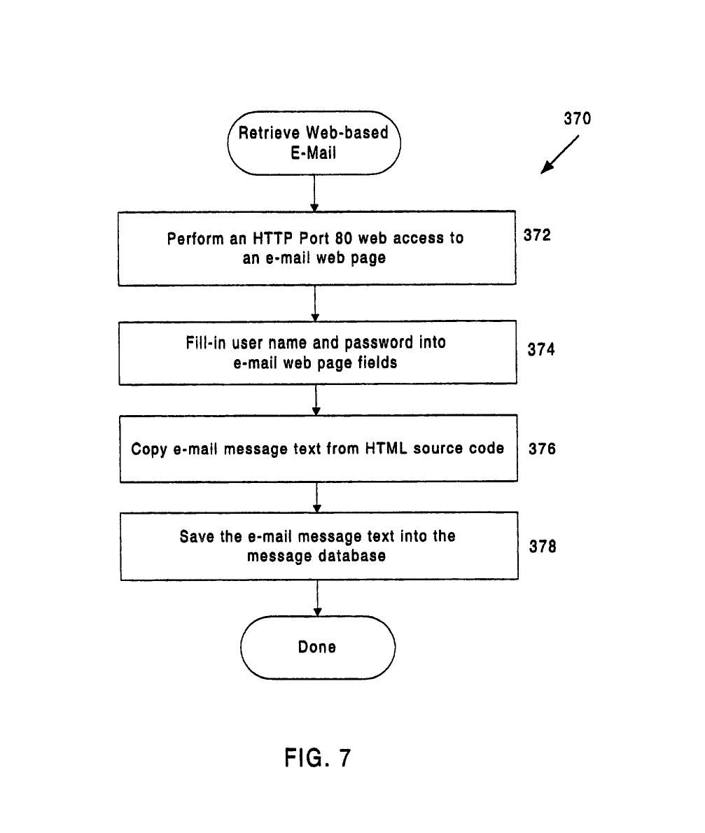

FIG. 7 illustrates a flowchart diagram 370 illustrating the process performed when retrieving web-based e-mail, in accordance with one embodiment of the present invention. When the phone server 122 of FIG. 2 is in the process of retrieving web-based e-mail, the method begins at an operation 372. In operation 372, an HTTP port 80 web access is performed to an e-mail web page. At this point, the method proceeds to an operation 374 where the user name and password are filled into the sign-in fields of the e-mail web page. The filling-in is preferably performed by a script.

Once the information has been provided in operation 374, the method proceeds to an operation 376 where the e-mail message text is identified and copied from the HTML source code or other language source code. The method then proceeds to an operation 378 where the e-mail message text is saved to the message database 128 of FIG. 2. At this point, the method for retrieving the web-based e-mail of flowchart 370 will be done. Other e-mail messages are accessed and retrieved by accessing POP3 servers, or any other e-mail formats.

As can be appreciated, the message management system of the present invention is a powerful solution for busy persons desiring control over his or her messaging sources. The message management system is a non-invasive solution which does not require a user to change his or her normal routine. That is, the user is not required to forward any or all calls to one number, and the user is able to access all message sources from any location in the world having an Internet connection. The system provides an easy to use interface that organizes each message in relation to where the message was retrieved. Still another advantage of the message management system is that users are able to quickly browse through all messages from all sources in text format (whether the original message was voice or text) so that non-important messages are not accessed until a later time or when desired. It is also pointed out that the message management system is a secure system that guards user information at each possible point. Therefore, users can rest assured that confidential messages are not accessed by unauthorized persons.

The invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include read-only memory, random-access memory, CD-ROMs, CD-Rs, CD-RWs, magnetic tapes, and other optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An Internet message management portal implementing program instructions for managing messages of remote message sources by way of the Internet, the instructions comprising:
program instructions for establishing message sources for a user, each message source having access and management information provided by the user;
program instructions for storing the access and management information for the message sources in a user database;
program instructions for accessing each of the message sources over the Internet at user defined times using the access and management information;
program instructions for copying messages from the message sources;
program instructions for saving the copied messages at a message database; and
program instructions to enable web browser access to the portal and to the message database to access the copied messages, the copied messages being displayed for the user to handle.

2. An Internet message management portal implementing program instructions for managing messages of remote message sources by way of the Internet as recited in claim 1, wherein the remote sources include voice mail sources, e-mail sources, fax sources, and multimedia data sources.
